(19) United States
(12) Patent Application Publication
(10) Pub. No.: US 2007/0156716 A1
(43) Pub. Date: Jul. 5, 2007

(54) Generic draft mechanism for business objects

(76) Inventors: Bare Said, St. Leon-Rot (DE); Martin Hartig, Speyer (DE)

Correspondence Address: KENYON & KENYON LLP, RIVERPARK TOWERS, SUITE 600, 333 W. SAN CARLOS ST., SAN JOSE, CA, 95110, US

(21) Appl. No.: 11/323,001

(22) Filed: Dec. 29, 2005

(51) Int. Cl. G06F 7/00; G06F 17/00

(52) U.S. Cl. 707/100

(57) ABSTRACT

A system and method for temporarily saving entries to the fields of a business object is disclosed. A draft manager may receive a first field entry of a set of field entries from a first user for an active instance of a business object. The draft manager may store a first temporary save draft of the active instance. The draft manager may assign the first temporary save draft to the first user. The draft manager may discard the first temporary save draft if the active instance is saved by, for example, a second user.

### BACKGROUND

The present invention-relates to a system for working with business objects and, in particular, using temporary store drafts to manage the fields of a business object over multiple sessions.

Large software applications are often composed of unmanageably large amounts of executable code. In order to facilitate creation and management of large software systems, then, the systems are often composed of many different business objects. Business objects are software components that encompass user interfaces, data, business rules, communication components and any other code that may relate to their function.

In order to simplify design of these large systems, business objects are often defined as collections of logically related functions and data. A large application designed to facilitate a typical business may have many different business objects. An ordering business object may be used to handle incoming orders or changes to existing orders. A shipping business object may be implemented to handle all shipping related tasks, such as arranging for deliveries or determining shipping times and costs. Business objects may handle some tasks independently while communicating with other business objects to complete other tasks.

FIG. 1 illustrates in a block diagram one system 100 for manipulating business objects. A system may have a set of business objects 110. Each business object may have a number of fields 120, representing a data value or an operation stored in the business object 110. Each field 120 may have a relation 130 indicating how that field interacts with other fields 120 of the business objects 110. A user may view the relation 130 using a portal page 140. When a portal page 140 is opened, that business object 110 is locked to prevent a second user from manipulating the business object as it is being manipulated by the first user.

When the user is initially constructing the business objects, that user must currently enter all the necessary data in a single session. As the business processes become more and more complex, entering all this data in a single session becomes prohibitive. Data is entered in a single session to prevent version conflict. The process of resolving two conflicting versions into a single version can lead to prohibitive computer processing overhead cost. The alternative is the development of two competing versions residing on the system together, wasting memory space and leading to system failures.

What is needed is a method of being able to save incomplete versions of a business object without having to resolve version conflict.

### BRIEF DESCRIPTION OF THE DRAWINGS

FIG. 1 illustrates in a block diagram one system for manipulating business objects.

FIG. 2 illustrates a possible configuration of a computer system to implement the application components under the present invention.

FIG. 3 illustrates one embodiment for a system to manipulate the fields of business objects.

FIG. 4 illustrates in a flowchart one embodiment of a method for manipulating the fields of business objects.

FIG. 5 illustrates in a flowchart one embodiment for a method for saving a temporary save draft.

FIG. 6 illustrates in a flowchart one embodiment of a method for reloading the TSD.

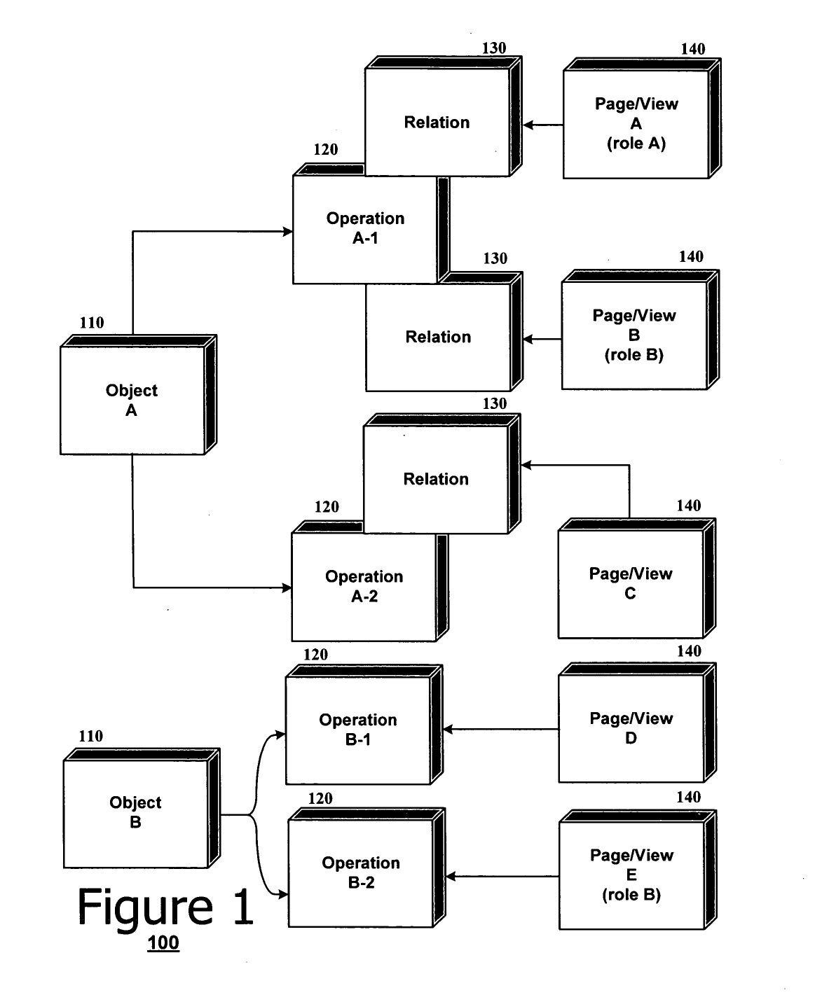

### DETAILED DESCRIPTION

A system and method for temporarily saving entries to the fields of a business object is disclosed. A draft manager may receive a first field entry of a set of field entries from a first user for an active instance of a business object. The draft manager may store a first temporary save draft of the active instance. The draft manager may assign the first temporary save draft to the first user. The draft manager may discard the first temporary save draft if the active instance is saved by, for example, a second user.

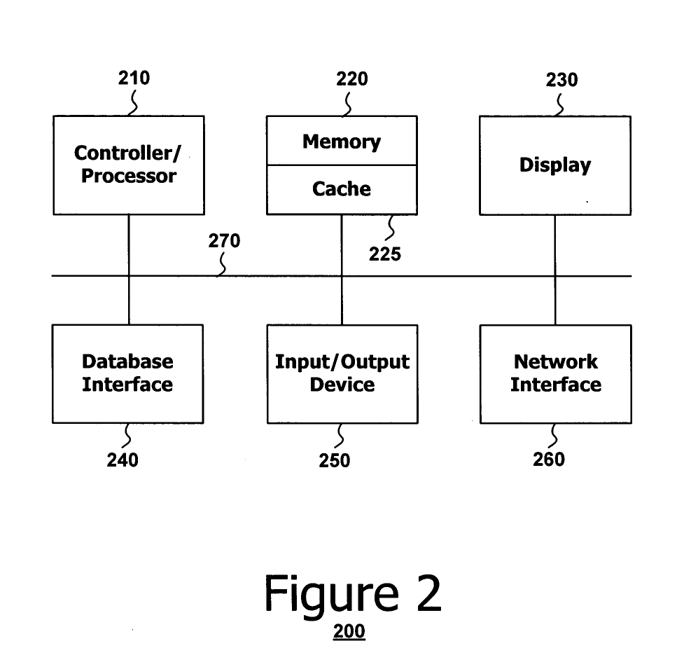

FIG. 2 illustrates a possible configuration of a computer system 200 to implement application components under the present invention. The computer system 200 may include a controller/processor 210, a memory 220 with a cache 225, display 230, database interface 240, input/output device interface 250, and network interface 260, connected through bus 270.

The controller/processor 210 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 220 may include volatile and nonvolatile data storage, including one or more electrical, magnetic or optical memories such as a RAM, cache, hard drive, CD-ROM drive, tape drive or removable storage disk. The memory may have a cache 225 to speed access to specific data.

The Input/Output interface 250 may be connected to one or more input devices that may include a keyboard, mouse, pen-operated touch screen or monitor, voice-recognition device, or any other device that accepts input. The Input/Output interface 250 may also be connected to one or more output devices, such as a monitor, printer, disk drive, speakers, or any other device provided to output data.

The network interface 260 may be connected to a communication device, modem, network interface card, a transceiver, or any other device capable of transmitting and receiving signals over a network. The components of the computer system 200 may be connected via an electrical bus 270, for example, or linked wirelessly.

Client software and databases may be accessed by the controller/processor 210 from memory 220 or through the database interface 240, and may include, for example, database applications, word processing applications, the client side of a client/server application such as a billing system, as well as components that embody the decision support functionality of the present invention. The computer system 200 may implement any operating system, such as Windows or UNIX, for example. Client and server software may be written in any programming language, such as ABAP, C, C++, Java or Visual Basic, for example.

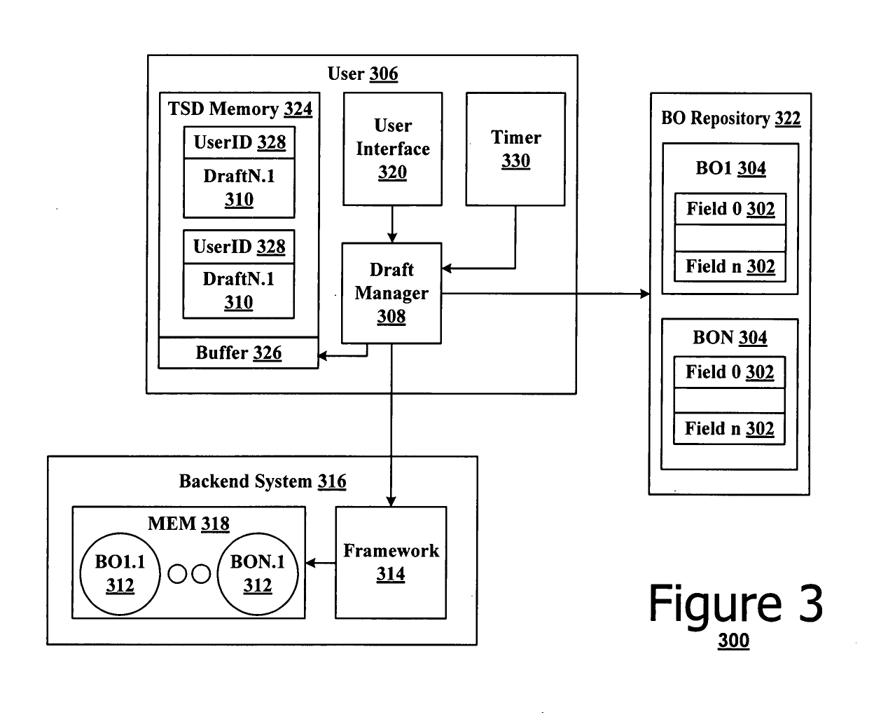

FIG. 3 illustrates one embodiment for a system 300 to manipulate the fields 302 of business objects 304. A user device 306 may be executing a draft manager 308 to create a temporary save draft (TSD) 310 that may be used to generate an instance 312 of a business object 304. The framework 314 of a backend system 316 may use the instances 312 of the business objects 304 to perform a variety of business processes. The framework 314 stores the instances 312 in a memory 318 of the backend system 316. Upon input from the user via a user interface 320, the draft manager 308 may select one or more business object 304 from the business object repository 322. The draft manager 308 may use the selected business object 304 as the basis for a TSD 310 of a business object instance 312. The draft manager 308 may store the TSD 310 in a TSD memory 324 at the user device 306 or elsewhere. The draft manager 308 may take updates from the user interface 320 and enter those updates into the TSD 310 via a buffer 326. The TSD memory 324 may associate the TSD 310 with a specific user identifier 328.

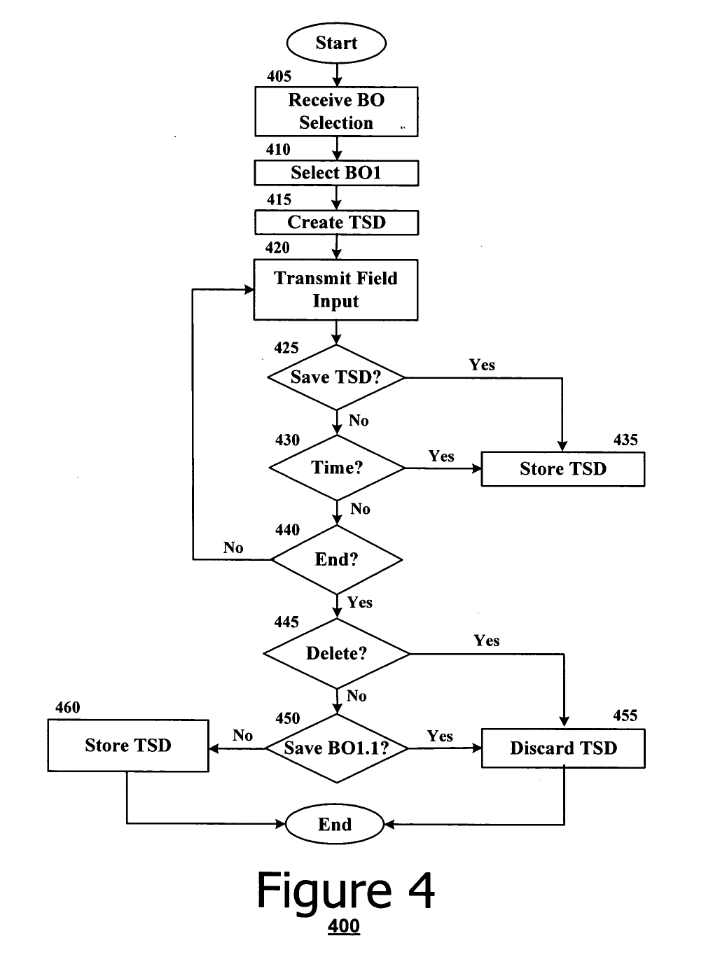

FIG. 4 illustrates in a flowchart one embodiment of a method 400 for manipulating the fields 304 of business objects 302. The draft manager 308 may receive a selection of a business object (BO) from the user (Block 405). The draft manager 308 may select the BO (Block 410) and create a TSD based upon the selected BO (Block 415). The draft manager 308 may transmit modifications to the TSD from the user interface 320 to the draft buffer 326 (Block 420). Upon a user input (Block 425) or after a time period has elapsed as specified by a timer 330 (Block 430), the TSD 310 may be stored in the memory 324 (Block 435). The draft manager 308 may continue to transmit field inputs from the user interface 320 until the user is finished (Block 440). If the user does not have further entries to make at a later date, the user may have the draft manager 308 delete the TSD 310 (Block 445) or save the TSD 310 as an instance 312 of the BO 304 with the backend system 316 (Block 450). Either action may result in the TSD 310 being discarded (Block 455). Otherwise, the TSD 310 is stored in the TSD memory 324 (Block 460).

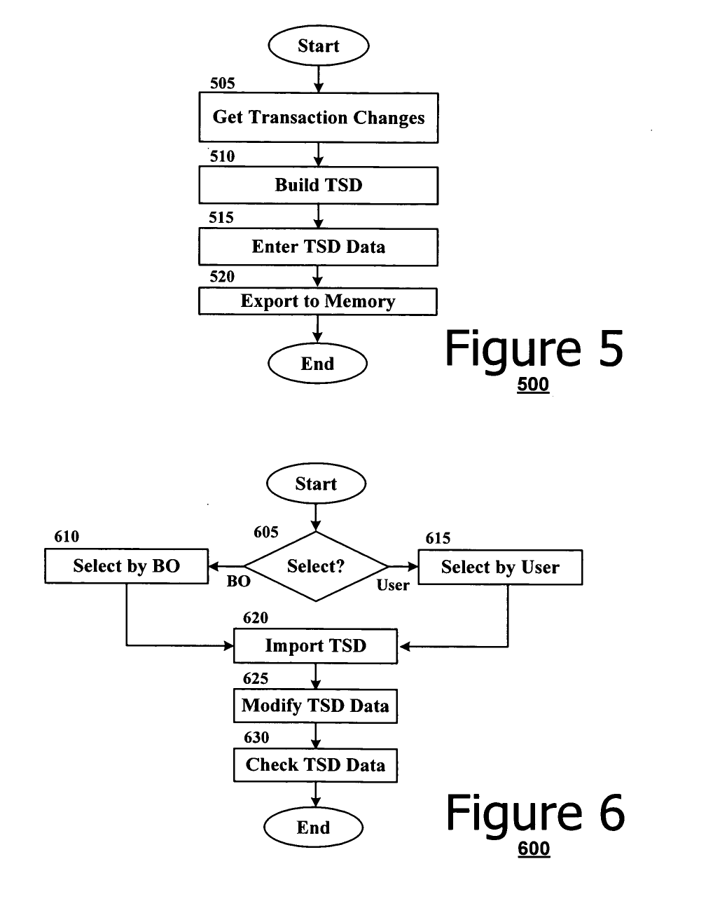

FIG. 5 illustrates in a flowchart one embodiment for a method 500 for saving a temporary save draft. The draft manager 308 may get transactional changes that have been traced by the framework 314 on the backend system 316 (Block 505) and builds the TSD data 310 (Block 510). The TSD data 310 may contain new image data plus tasks such as create, update, delete and others. The TSD data 310 may have a similar format as data passed through a single session business object instance 312 build. The draft manager 308 may enter the TSD data (Block 515) and export the TSD 310 to the TSD memory 324 (Block 520).

FIG. 6 illustrates in a flowchart one embodiment of a method 600 for reloading the TSD 310. The TSD 310 may be selected by a number of methods (Block 605), including by specifying a BO type (Block 610) and by retrieving all drafts associated with a specific user (Block 615). The selected TSD 310 may be imported from the TSD memory 324 (Block 620). The draft manager 308 may then modify the TSD data 310 (Block 625). In one embodiment, only fields which are designated as editable are considered for modification. Certain data fields may be modified based on executable data in other fields, requiring that these data fields be triggered upon modification. The draft manager 308 may then check the TSD data for any improperly executed data dependencies (Block 630).

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. In a computer system, a method comprising:
receiving a first field entry of a set of field entries for an active instance of a business object;
storing a first temporary save draft of the active instance; and
discarding the first temporary save draft if the active instance is saved.

2. The method of claim 1, further comprising:
reloading the first temporary save draft;
receiving a completed set of field entries for the active instance; and
storing the active instance.

3. The method of claim 1, wherein the first temporary save draft is stored upon receiving an indication from a user.

4. The method of claim 1, wherein the first temporary save draft is stored based upon a timer.

5. The method of claim 1, further comprising deleting the first temporary save draft upon receiving an indication from a user.

6. The method of claim 1, further comprising assigning the first temporary save draft to a user.

7. The method of claim 6, further comprising retrieving every temporary save draft assigned to the user.

8. Computer readable medium storing a set of program instructions that, when executed by a client device, cause the client device to:
receiving a first field entry of a set of field entries for an active instance of a business object;
storing a first temporary save draft of the active instance; and
discarding the first temporary save draft if the active instance is saved.

9. The set of program instructions of claim 8, further comprising:
reloading the first temporary save draft;
receiving a completed set of field entries for the active instance; and
storing the active instance.

10. The set of program instructions of claim 8, wherein the first temporary save draft is stored upon receiving an indication from a user.

11. The set of program instructions of claim 8, wherein the first temporary save draft is stored based upon a timer.

12. The set of program instructions of claim 8, further comprising deleting the first temporary save draft upon receiving an indication from a user.

13. The set of program instructions of claim 8, further comprising assigning the first temporary save draft to a user.

14. The set of program instructions of claim 13, further comprising retrieving every temporary save draft assigned to the user.

15. A business object processing system comprising:
a user interface to receive a first field entry of a set of field entries for an active instance of a business object;
a data storage medium to store a first temporary save draft of the active instance; and
a draft manager to discard the first temporary save draft if the active instance is saved.

16. The business object processing system of claim 15, wherein:
the processor reloads the first temporary save draft;
the user interface receives a completed set of field entries for the active instance; and
the active instance is stored.

17. The business object processing system of claim 15, wherein the first temporary save draft is stored upon receiving an indication from a user.

18. The business object processing system of claim 15, wherein the first temporary save draft is stored based upon a timer.

19. The business object processing system of claim 15, wherein the first temporary save draft is deleted upon receiving an indication from a user.

20. The business object processing system of claim 15, wherein the draft manager assigns the first temporary save draft to the first user.
